(19) United States
(12) Patent Application Publication
(10) Pub. No.: US 2004/0253890 A1
(43) Pub. Date: Dec. 16, 2004

(54) Fibers with lower edgewise compression strength and sap containing composites made from the same

(76) Inventors: Estelle Anne Ostgard, Appleton, WI (US); Arvinder Pal Singh Kainth, Neenah, WI (US); Rob David Everett, Appleton, WI (US)

Correspondence Address: KIMBERLY-CLARK WORLDWIDE, INC., 401 NORTH LAKE STREET, NEENAH, WI, 54956

(21) Appl. No.: 10/461,942

(22) Filed: Jun. 13, 2003

(51) Int. Cl. B32B 5/26; B32B 9/04; B32B 5/02

(52) U.S. Cl. 442/153; 442/152; 442/35

(57) ABSTRACT

The present invention related to fibers having controlled peak load values to achieve 50% compression of the fibers, compressive load at 50% compression of the fibers, and/or compressive energy value to achieve 50% compression of the fibers. The present invention relates to treatments for fibers to manipulate these values and new fibers having the desired peak load values to achieve 50% compression of the fibers, compressive load at 50% compression of the fibers, and/or compressive energy value to achieve 50% compression of the fibers. The present invention also relates to absorbent composites employing superabsorben materials having the desired peak load values to achieve 50% compression of the fibers, compressive load at 50% compression of the fibers, and/or compressive energy value to achieve 50% compression of the fibers.

### BACKGROUND

People rely on absorbent articles are in their daily lives.

Absorbent articles, including adult incontinence articles, feminine care articles, and diapers, are generally manufactured by combining a substantially liquid-permeable topsheet; a substantially liquid-impermeable backsheet attached to the topsheet; and an absorbent composite located between the topsheet and the backsheet. When an absorbent article is worn, the liquid-permeable topsheet is positioned next to the body of the wearer. The topsheet allows passage of bodily fluids into the absorbent composite. The liquid-impermeable backsheet helps prevent leakage of fluids held in the absorbent composite. The absorbent composite is designed to have desirable physical properties, e.g. a high absorbent capacity and high absorption rate, so that bodily fluids may be transported from the skin of the wearer into the disposable absorbent article.

The absorbent composite used in the absorbent articles typcially consist of an absorbent material, such as a superabsorbent material, mixed with a fibrous matrix comprising natural and/or synthetic fibers. The fibers typcially provide mechanical strength, integrity, and stiffness to the structure of the absorbent composites within the absorbent articles. The fibers also typically provide surface energy to distribute the fluid within the absorbent composite of the absorbent article.

The mechanical properties, such as stiffness and compressive strength, provided at least in part by the fibers, determine the absorptive function of the absorbent composite when the absorbent article is exposed to externally imposed stresses during use. Absorbent composites having high stiffness values may provide absorbent articles having better integrity within the fiberous matrix and absorbent material structure of the absorbent composite during use. However, such absorbent composites may also result in fibrous matrix and absorbent material structures which do not respond favorably to externally imposed stresses encountered by absorbent articles during use. Such absorbent articles may feel “stiff” to the user and may causing discomfort during use. Alternatively, absorbent articles comprising absorbent composites having low stiffness values typically do not “resist” deformation during use and may respond more favourably to externally imposed stress. Such arbsorbent articles feel “soft”, flexible, and/or comformable to the user.

### SUMMARY

The present invention is directed to fibers and/or fibrous matrixes having reduced edgewise compression values and the absorbent composites comprising such fibers and/or fibrous matrixes having increased flexibility, compressability, and/or softness. The absorbent composites may also comprise superabsorbent materials. The absorbent material may be homogenously mixed within the fibrous matrix of the absorbent composite. Alternatively, the absorbent material may be arranged in a gradient or zoned within the fibrous matrix of the absorbent composite.

The fibers of the present invention may comprise a plurality of untreated fibers having a peak load value to achieve 50% compression of the plurality of untreated fibers and an additive which interacts with the untreated fibers thereby defining a plurality of treated fibers having a peak load value to achieve 50% compression of the plurality of the treated fibers. The peak load value of the treated fibers may be about 75% of the peak load value to achieve 50% compression of the untreated fibers or less. The fibers may be incorporated into an absorbent composite which may include a water swellable, water insoluble superabsorbent material.

The fibers of the present invention may comprise a plurality of untreated fibers having a compressive load at 50% compression of the plurality of untreated fibers and an additive which interacts with the untreated fibers thereby defining a plurality of treated fibers having a compressive load at 50% compression of the plurality of the treated fibers. The compressive load of the treated fibers may be about 75% of the compressive load of the untreated fibers or less. The fibers may be incorporated into an absorbent composite which may include a water swellable, water insoluble superabsorbent material.

The fibers of the present invention may comprise a plurality of untreated fibers having a compressive energy value to achieve 50% compression of the plurality of untreated fibers and an additive which interacts with the untreated fibers thereby defining a plurality of treated fibers having a compressive energy value to achieve 50% compression of the plurality of the treated fibers. The compressive energy value of the treated fibers may be about 75% of the compressive energy value of the untreated fibers or less. The fibers may be incorporated into an absorbent composite which may include a water swellable, water insoluble superabsorbent material.

These and other features, aspects, and advantages of the present invention will become better understood with regard to the following description, appended claims, and accompanying drawings.

### BRIEF DESCRIPTION OF DRAWINGS OF EXAMPLES AND/OR REPRESENTATIVE EMBODIMENTS

FIG. 1 shows a front perspective view of an absorbent composite;

FIG. 2 shows a plan view of an absorbent article, such as a child's traning pant, in a partially disassembled, streatched flat state, showing the surface of the absorbent article that faces the wearer when the absorbent article is worn, and with portion cut away to show the underlying features including an absorbent composite;

FIG. 3 shows an enlarged, fragmentary front perspective view of an absorbent composite with parts broken away to show internal construction; and,

FIG. 4 shows an example of Edgewise Compression of a material in relation to an applied load on a plot of load (y axis) versus percent compression (x axis);

### DEFINITIONS

Within the context of this specification, each term or phrase below will include the following meaning or meanings.

“Absorbency Under Load” (AUL) refers to the measure of the liquid retention capacity of a material under mechanical load. It is determined by a test which measures the amount, in grams, of a 0.9% by weight aqueous sodium chloride solution a gram of material may absorb in 1 hour under an applied load or restraining pressure of about 0.3 pound per square inch (2,000 Pascals). A procedure for determining AUL is provided in U.S. Pat. No. 5,601,542, which is incorporated by reference in its entirety in a manner consistent herewith.

“Fiber” and “Fibrous Matrix” includes, but is not limited to natural fibers, synthetic fibers and combinations thereof. Examples of natural fibers include cellulosic fibers (e.g., wood pulp fibers), cotton fibers, wool fibers, silk fibers and the like, as well as combinations thereof. Synthetic fibers can include rayon fibers, glass fibers, polyolefin fibers, polyester fibers, polyamide fibers, polypropylene.

“Free Swell Capacity” refers to the result of a test which measures the amount in grams of an aqueous 0.9% by weight sodium chloride solution that a gram of material may absorb in 1 hour under negligible applied load.

“Gradient” refers to a graded change in the magnitude of a physical quantity, such as the quantity of superabsorbent material present in various locations of an absorbent pad, or other pad characteristics such as mass, density, or the like.

“Homogeneously mixed” refers to the uniform mixing of two or more substances within a composition, such that the magnitude of a physical quantity of each of the substances remains substantially consistent throughout the composition.

“Layer” refers when used in the singular may have the dual meaning of a single element or a plurality of elements.

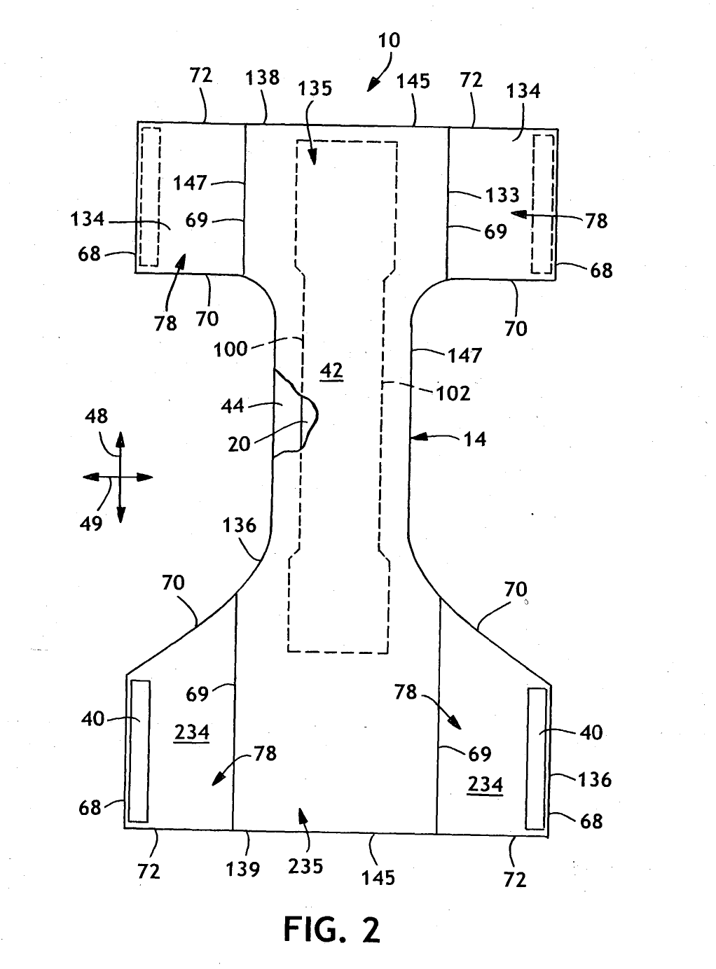

“Longitudinal” and “transverse” refer to customary meaning, as indicated by the longitudinal and transverse axes as depeicted in FIG. 2. The longitudinal axis lies in the plane of the absorbent article and is generally parallel to a vertical plane that bisects a standing wearer into left and right body halves when the absorbent article is worn. The transverse axis lies in the plane of the absorbent article generally perpendicular to the longitudinal axis. The absorbent article as illustrated is typically longer in the longitudinal direction than in the transverse direction.

“Meltblown fiber” means fibers formed by extruding a molten thermoplastic material through a plurality of fine, usually circular, die capillaries as molten threads or filaments into converging high velocity heated gas (e.g., air) streams which attenuate the filaments of molten thermoplastic material to reduce their diameter, which may be to microfiber diameter. Thereafter, the meltblown fibers are carried by the high velocity gas stream and are deposited on a collecting surface to form a web of randomly dispersed meltblown fibers. Such a process is disclosed for example, in U.S. Pat. No. 3,849,241 to Butin et al. Meltblown fibers are microfibers which may be continuous or discontinuous, are generally smaller than about 0.6 denier, and are generally self bonding when deposited onto a collecting surface. Meltblown fibers used in the present invention are suitably substantially continuous in length.

“Polymers” include, but are not limited to, homopolymers, copolymers, such as for example, block, graft, random and alternating copolymers, terpolymers, etc. and blends and modifications thereof. Furthermore, unless otherwise specifically limited, the term “polymer” shall include all possible geometrical configurations of the material. These configurations include, but are not limited to isotactic, syndiotactic and atactic symmetries.

“Superabsorbent” or “superabsorbent material” refers to a water-swellable, water-insoluble organic or inorganic material capable, under the most favorable conditions, of absorbing at least about 10 times its weight and, more particularly, at least about 20 times its weight in an aqueous solution containing 0.9 weight percent sodium chloride. The superabsorbent materials may be natural, synthetic and modified natural polymers and materials. In addition, the superabsorbent materials may be inorganic materials, such as silica gels, or organic compounds such as cross-linked polymers. The superabsorbent materials of the present invention may embody various structure configurations including particles, fibers, flakes, and spheres.

“Surface” refers to any layer, film, woven, nonwoven, laminate, composite, or the like, where pervious or impervious to air, gas, and/or, liquids.

“Spunbonded fiber” refers to small diameter fibers which are formed by extruding molten thermoplastic material as filaments from a plurality of fine capillaries of a spinnerette having a circular or other configuration, with the diameter of the extruded filaments then being rapidly reduced as by, for example, in U.S. Pat. No. 4,340,563 to Appel et al.; U.S. Pat. No. 3,692,618 to Dorschner et al.; U.S. Pat. No. 3,802,817 to Matsuki et al.; U.S. Pat. Nos. 3,338,992 and 3,341,394 to Kinney; U.S. Pat. No. 3,502,763 to Hartmann; U.S. Pat. No. 3,502,538 to Petersen; and, U.S. Pat. No. 3,542,615 to Dobo et al., each of which is incorporated by reference in its entirety in a manner consistent herewith. Spunbond fibers are quenched and generally not tacky when they are deposited onto a collecting surface. Spunbond fibers are generally continuous and often have average deniers larger than about 0.3, more particularly, between about 0.6 and 10.

These terms may be defined with additional language in the remaining portions of the specification.

### DETAILED DESCRIPTION OF REPRESENTATIVE EMBODIMENTS

The present invention is directed to a fiber and/or fibrous matrix having reduced edgewise compression values and the absorbent composites comprising such fibers and/or fibrous matrixes having increased flexibility, compressability, and/or softness. The absorbent composites may further comprise absorbent materials. The absorbent composite may be produced by any method known in the art. The fibers and/or fibrous matrix of the present invention of the present invention may suitably be incorporated into absorbent composites, and ultimately into absorbent articles. The term “absorbent article” includes without limitation diapers, training pants, swim wear, absorbent underpants, baby wipes, incontinence products, feminine hygiene products and medical absorbent products (for example, absorbent medical garments, underpads, bandages, drapes, and medical wipes).

As used herein, the term “incontinence products” includes absorbent underwear for children, absorbent garments for children or young adults with special needs such as autistic children or others with bladder/bowel control problems as a result of physical disabilities, as well as absorbent garments for incontinent older adults.

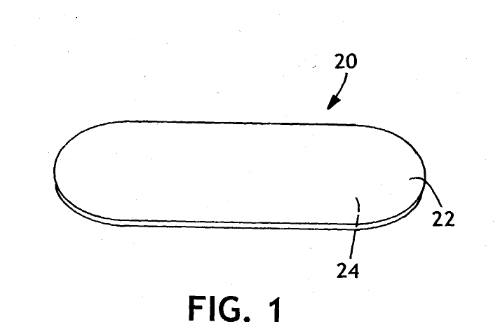

Referring to FIG. 1, an absorbent composite 20 into which the fibers and/or fibrous matrix of the present invention may be incorporated is illustrated. The absorbent composite 20 includes a bodyside surface 22 which is configured to face and/or come into contact with the user, and a garment facing surface 24 opposite the bodyside surface 22 which is configured to face away from the user. The size and shape of the absorbent composite 20 may be configured to fit within virtually any absorbent article. Examples of suitable shapes include oval, rectangular, and hourglass-shaped. It is desireable that the absorbent composite 20 be generally compressible, conformable, nonirritating to a wearer's skin, and capable of absorbing and retaining liquids and certain body wastes.

The absorbent composites 20 of absorbent articles typically contain superabsorbent material, in relatively high quantities in some cases, in various forms such as superabsorbent fibers and/or superabsorbent particles, homogeneously mixed with a matrix material, such as cellulose fluff pulp or other fiber. The mixture of superabsorbent material and fiber may be homogeneous throughout the absorbent composite 20 or the superabsorbent material may be strategically located within the absorbent composite 20, such as forming a gradient within the fibrous matrix. For example, more superabsorbent material may be present at one end of the absorbent composite 20 than at an opposite end of the absorbent composite 20. Alternatively, more superabsorbent material may be present along the bodyside surface 22 of the absorbent composite 20 than along the garment facing surface 24 of the absorbent composite 20 or more superabsorbent material may be present along the bottom surface of the absorbent composite 20 than along the bodyside surface 22 of the absorbent composite 20, thus forming a gradient of superabsorbent material within the absorbent composite 20. Due to the gradient, the concentration of superabsorbent material may vary throughout the absorbent composite 20 by about 0.01 to about 0.40 grams per cubic centimeter, or by about 0.05 to about 0.35 grams per cubic centimeter, or by about 0.15 to about 0.25 grams per cubic centimeter. The levels of superabsorbent materials may range between about 30 and about 85 wt %, suitably between about 40 and about 80 wt %, more suitably between about 50 and about 75 wt % based on total weight of the absorbent composite 20. Consequently, levels of fiber may range between about 15 and about 70 wt %, more suitably between about 20 and about 60 wt %, most suitably between about 25 and about 50 wt % based on total weight of the absorbent composite 20. One skilled in the art will appreciate the various embodiments available for absorbent composites 20. The fiber and/or fibrous matrix of the present invention may be used in these and other various embodiments of absorbent composites 20.

Absorbent composites 20 comprising a superabsorbent material typically include a fibrous matrix which contains the superabsorbent material. The fibrous matrix is often made from a fiber material or foam material, but one skilled in the art will appreciate the various embodiments of the fibrous matrix suitable for use in absorbent composites 20. One such fibrous matrix is made of a cellulose fluff pulp. The cellulose fluff pulp suitably includes wood pulp fluff. The cellulose pulp fluff may be exchanged, in whole or in part, with synthetic, polymeric fibers (e.g., meltblown fibers). Synthetic fibers are not required in the absorbent composites 20 of the present invention, but may be included. One preferred type of wood pulp fluff is identified with the trade designation CR1654, available from Bowater, Childersburg, Ala., U.S.A., and is a bleached, highly absorbent wood pulp containing primarily soft wood fibers. The cellulose fluff pulp may be homogeneously mixed with the superabsorbent material. Within the absorbent article, the homogeneously mixed fluff and superabsorbent material may be selectively placed into desired zones of higher concentration to better contain and absorb body exudates. For example, the mass of the homogeneously mixed fluff and superabsorbent materials may be controllably positioned such that more basis weight is present in a front portion of the absorbent composite 20 than in a back portion of the absorbent composite 20.

Suitable superabsorbent materials that may be employed with the fiber and/or fibrous matrix of the present invention may be selected from natural, synthetic, and modified natural polymers and materials. The superabsorbent materials may be inorganic materials, such as silica gels, or organic compounds, including natural materials such as agar, pectin, guar gum, and the like, as well as synthetic materials, such as synthetic hydrogel polymers. Such hydrogel polymers include, for example, alkali metal salts of polyacrylic acids; polyacrylamides; polyvinyl alcohol; ethylene maleic anhydride copolymers; polyvinyl ethers; hydroxypropylcellulose; polyvinyl morpholinone; polymers and copolymers of vinyl sulfonic acid, polyacrylates, polyacrylamides, polyvinyl pyridine; polyamines; and, combinations thereof. Other suitable polymers include hydrolyzed acrylonitrile grafted starch, acrylic acid grafted starch, and isobutylene maleic anhydride copolymers and combinations thereof. The hydrogel polymers are suitably lightly crosslinked to render the material substantially water-insoluble. Crosslinking may, for example, be by irradiation or by covalent, ionic, Van der Waals, or hydrogen bonding. The superabsorbent materials of the present invention may be in any form suitable for use in absorbent structures, including, particles, fibers, flakes, spheres, and the like.

Typically, a superabsorbent material or polymer is capable of absorbing at least about 10 times its weight in a 0.9 weight percent aqueous sodium chloride solution, and particularly is capable of absorbing more than about 20 times its weight in 0.9 weight percent aqueous sodium chloride solution. Superabsorbent polymers are available from various commercial vendors, such as Dow Chemical Company located in Midland, Mich., U.S.A., and Stockhausen Inc., Greensboro, N.C., USA. Other superabsorbent polymers are described in U.S. Pat. No. 5,601,542 issued Feb. 11, 1997, to Melius et al.; U.S. patent application Ser. No. 09/475,829 filed in December 1999 and assigned to Kimberly-Clark Corporation; and, U.S. patent application Ser. No. 09/475,830 filed in December 1999 and assigned to Kimberly-Clark Corporation, each of which is hereby incorporated by reference in a manner consistent herewith.

Other examples of commercial superabsorbent materials include polyacrylate materials available from Stockhausen under the tradename FAVOR®. Examples include FAVOR® SXM 77, FAVOR®) SXM 880, and FAVOR®) SXM 9543. Other polyacrylate superabsorbent materials are available from Dow Chemical, USA under the tradename DRYTECH®, such as DRYTECH®) 2035.

Superabsorbent materials may be in the form of particles which, in the unswollen state, have maximum cross-sectional diameters typically within the range of from about 50 microns to about 1,000 microns, suitably within the range of from about 100 microns to about 800 microns, as determined by sieve analysis according to American Society for Testing Materials (ASTM) Test Method D-1921. It is understood that the particles of superabsorbent material, falling within the ranges described above, may include solid particles, porous particles, or may be agglomerated particles including many smaller particles agglomerated into particles within the described size ranges.

The absorbent composite 20 may have a thickness of between about 1 and about 4 millimeters (mm), more suitably between about 1 and about 3 mm, more suitably between about 1 and about 2 mm. As a result, the density of the absorbent composite 20 is at least about 0.15 grams per cubic centimeter (g/cc). More suitably, the density of the absorbent composite 20 is at least about 0.25 g/cc, and more suitably, the density of the absorbent composite 20 is at least about 0.35 g/cc.

The absorbent composite 20 of the present invention suitably has an absorbent saturation capacity between about 14 and about 40 grams 0.9 w/v % saline solution per gram of absorbent composite 20, alternatively at least about 16 grams/gram, or as another alternative at least about 18 grams/gram. The method by which the absorbent saturation capacity is determined is set forth in detail below.

Fibers suitable for use in the present invention (e.g., to be treated or modified so that they have recited edgewise compression strength values) are known to those skilled in the art. Examples of fibers suitable for use in the present invention include, cellulosic fibers such as wood pulp, cotton linters, cotton fibers and the like; synthetic polymeric fibers such as polyolefin fibers, polyamide fibers, polyester fibers, polyvinyl alcohol fibers, polyvinyl acetate fibers, synthetic polyolefin wood pulp fibers, and the like; as well as regenerated cellulose fibers such as rayon and cellulose acetate microfibers. Mixtures of various fiber types are also suitable for use. For example, a mixture of cellulosic fibers and synthetic polymeric fibers may be used. As a general rule, the fibers will have a length-to-diameter ratio of at least about 2:1, suitably of at least about 5:1. As used herein, “diameter” refers to a true diameter if generally circular fibers are used or to a maximum transverse cross-sectional dimension if non-circular, e.g., ribbon-like, fibers are used. The fibers will generally have a length of from about 0.5 millimeter to about 25 millimeters, suitably from about 1 millimeter to about 6 millimeters. Fiber diameters will generally be from about 0.001 millimeter to about 1.0 millimeter, suitably from about 0.005 millimeter to about 0.05 millimeter. For reasons such as economy, availability, physical properties, and ease of handling, cellulosic wood pulp fibers are suitable for use in the present invention.

Other fibers useful for purposes of the present invention are resilient fibers that include high-yield pulp fibers (further discussed below), flax, milkweed, abaca, hemp, cotton, or any of the like that are naturally resilient or any wood pulp fibers that are chemically or physically modified, e.g. crosslinked or curled, that have the capability to recover after deformation from preparing the absorbent composite 20, as opposed to non-resilient fibers which remain deformed and do not recover after preparing the absorbent composite 20.

As used herein, “high yield pulp fibers” are those papermaking fibers produced by pulping processes providing a yield of about 65 percent or greater, more specifically about 75 percent or greater, and still more specifically from about 75 to about 95 percent. Such pulping processes include bleached chemithermomechanical pulp (BCTMP), chemithermomechanical pulp (CTMP), pressure/pressure thermomechanical pulp (PTMP), thermomechanical pulp (TMP), thermomechanical chemical pulp (TMCP), high yield sulphite pulps, and high yield kraft pulps, all of which leave the resulting fibers with high levels of lignin. Suitable high-yield pulp fibers are characterized by being comprised of comparatively whole, relatively undamaged tracheids, high freeness (over 250 CSF), and low fines content (less than 25 percent by the Britt jar test).

Absorbent composites 20 may also contain any of a variety of chemical additives or treatments, fillers or other additives, such as clay, zeolites and/or other odor-absorbing material, for example activated carbon carrier particles or active particles such as zeolites and activated carbon. Absorbent composites 20 may also include binding agents, such as crosslinkable binding agents or adhesives, and/or binder fibers, such as bicomponent fibers. Absorbent composites 20 may or may not be wrapped or encompassed by a suitable tissue wrap that maintains the integrity and/or shape of the absorbent composite 20.

The fibers and/or fibrous matrix of the present invention as well as the absorbent composites 20 in which the fibers and/or fibrous matrix may be incorporated exhibit good edgewise compression properties for user comfort and acceptance. The method by which edgewise compression may be measured is set forth in detail below. The absorbence performance of the absorbent composites 20 incorporating the fiber and/or fibrous matrix is comparable to conventional absorbent composites.

FIG. 2 shows an absorbent article 10, such as a child's training pant, in a partially disassembled, stretched flat state with the absorbent composite 20 of the present invention incorporated therein, showing a bodyside surface of the absorbent article 10 that faces the user when the absorbent article 10 is worn. An absorbent chassis 14 defines a pair of transversely opposed side edges 136 and a pair of longitudinally opposed waist edges, which are designated front waist edge 138 and back waist edge 139. When the absorbent article 10 is in a fastened position (not shown), the absorbent chassis 14 also defines a waist opening along the front waist edge 138 and the back waist edge 139 and two leg openings along the transversely opposed side edges 136. The absorbent chassis 14 also includes a somewhat rectangular composite structure 133, a pair of transversely opposed front side panels 134, and a pair of transversely opposed back side panels 234. The composite structure 133 and side panels 134 and 234 may be integrally formed, or may include two or more separate elements, as shown in FIG. 2.

The illustrated composite structure 133 includes an outer cover 44, a bodyside liner 42 which is connected to the outer cover 44 in a superposed relation, and the absorbent composite 20 of the present invention which is located between the outer cover 44 and the bodyside liner 42. The rectangular composite structure 133 has opposite linear end edges 145 that form portions of the front and back waist edges 138 and 139, and opposite linear, or curvilinear, side edges 147 that form portions of the side edges 136 of the absorbent chassis 14. For reference, arrows 48 and 49 depicting the orientation of the longitudinal axis and the transverse axis, respectively, of the absorbent article 10 are illustrated in FIG. 2.

The liquid permeable body side liner 42 is illustrated as overlying the outer cover 44 and the absorbent composite 20 (FIG. 2), and may but need not have the same dimensions as the outer cover 44. The body side liner 42 is desirably compliant, soft feeling, and non irritating to the child's skin. Further, the body side liner 42 may be less hydrophilic than the absorbent composite 20, to present a relatively dry surface to the user and permit liquid to readily penetrate through its thickness. The absorbent composite 20 (FIG. 2) is positioned between the outer cover 44 and the body side liner 42, which components can be joined together by any suitable means, such as adhesives, as is well known in the art.

The absorbent chassis 14 may also incorporate other materials that are designed primarily to receive, temporarily store, and/or transport liquid along the mutually facing surface with the absorbent composite 20, thereby maximizing the absorbent capacity of the absorbent chassis 14. One suitable material is referred to as a surge layer (not shown) and may be, for example, a material having a basis weight of about 50 grams per square meter, and including a through-air-bonded-carded web of a homogenous blend of 60 percent 3 denier bicomponent fiber including a polyester core/polyethylene sheath, commercially available from KoSa Corporation, and 40 percent 6 denier polyester fiber, commercially available from KoSa Corporation, in Salisbury, N.C., U.S.A. Other surge compositions are possible, and selected materials are described herein.

The outer cover 44 desirably includes a material that is substantially liquid impermeable, and can be elastic, stretchable or nonstretchable. The outer cover 44 may be a single layer of liquid impermeable-material, but desirably includes a multi-layered laminate structure in which at least one of the layers is liquid impermeable. For instance, the outer cover 44 may include a liquid permeable outer layer and a liquid impermeable inner layer that are suitably joined together by a laminate adhesive (not shown). Suitable laminate adhesives, which may be applied continuously or intermittently as beads, a spray, parallel swirls, or the like, can be obtained from Findley Adhesives, Inc., of Wanwatosa, Wis., U.S.A., or from National Starch and Chemical Company, Bridgewater, N.J., U.S.A. The liquid permeable outer layer may be any suitable material and desirably one that provides a generally clothlike texture. One example of such a material is a 20 gsm (grams per square meter) spunbond polypropylene nonwoven web. The outer layer may also be made of those materials of which liquid permeable bodyside liner 42 is made. While it is not a necessity for the outer layer to be liquid permeable, it may be desired that it provides a relatively cloth-like texture to the user.

The inner layer of the outer cover 44 may be both liquid and vapor impermeable, or may be liquid impermeable and vapor permeable. The inner layer may be desirably manufactured from a thin plastic film, although other flexible liquid impermeable materials may also be used. The inner layer, or the liquid impermeable outer cover 44 when a single layer, prevents waste material from wetting articles, such as bedsheets and clothing, as well as the user and caregiver. A suitable liquid impermeable film for use as a liquid impermeable inner layer, or a single layer liquid impermeable outer cover 44, is a 0.02 5 millimeter polyethylene film commercially available from Huntsman Packaging of Newport News, Va., U.S.A. If the outer cover 44 is a single layer of material, it may be embossed and/or matte finished to provide a more cloth-like appearance. As earlier mentioned, the liquid impermeable material may permit vapors to escape from the interior of the disposable absorbent article 10, while still preventing liquids from passing through the outer cover 44. A suitable “breathable” material is composed of a microporous polymer film or a nonwoven fabric that has been coated or otherwise treated to impart a desired level of liquid impermeability. A suitable microporous film is a PMP-1 film material commercially available from Mitsui Toatsu Chemicals, Inc., Tokyo, Japan, or an XKO-8044 polyolefin film commercially available from 3M Company, Minneapolis, Minn. Other similar materials with varying degrees of liquid permeability are spunbond meltblown webs, spunbond/meltblown/spunbond hydrophobic, uniformly formed spunbond, or bicomponent webs. A balance of barrier and permeability may be adjusted with fiber size and basis weight.

The bodyside liner 42 may be manufactured from a wide selection of web materials, such as synthetic fibers (for example, polyester or polypropylene fibers), natural fibers (for example, wood or cotton fibers), a combination of natural and synthetic fibers, porous foams, reticulated foams, apertured plastic films, or the like. Various woven and nonwoven fabrics may be used for the bodyside liner 42. For example, the bodyside liner 42 may be composed of a meltblown or spunbonded web of polyolefin fibers. The bodyside liner 42 may also be a bonded-carded web composed of natural and/or synthetic fibers. The bodyside liner 42 may be composed of a substantially hydrophobic material, and the hydrophobic material may, optionally, be treated with a surfactant or otherwise processed to impart a desired level of Nettability and hydrophilicity. For example, the material may be surface heated with about 0.28 weight percent of a surfactant commercially available from the Rohm and Haas Co. 30 under the trade designation Triton X-102. Other suitable surfactants are commercially available from Uniqema Inc., a division of ICI of New Castle, Del., under the trade designation Ahcovel, and from Cognis Corporation of Ambler, Pa., produced in Cincinnati, Ohio, and sold under the trade designation Glucopon 220. The surfactant may be applied by any conventional means, such as spraying, printing, brush coating or the like. The surfactant may be applied to the entire bodyside liner 42 or may be selectively applied to particular sections of the bodyside liner 42, such as the medial section along the longitudinal centerline.

A suitable liquid permeable bodyside liner 42 is a nonwoven bicomponent web having a basis weight of about 27 gsm. The nonwoven bicomponent web may be a spunbond bicomponent web, or a bonded carded bicomponent web. Suitable bicomponent staple fibers include a polyethylene/polypropylene bicomponent fiber available from CHISSO Corporation, Osaka, Japan. In this particular bicomponent fiber, the polypropylene forms the core and the polyethylene forms the sheath of the fiber. Other fiber orientations are possible, such as multi-lobe, side-by-side, islands in the sea, or the like. While the outer cover 44 and the bodyside liner 42 may include elastomeric materials, it may be desirable in some embodiments for the composite structure 133 to be generally inelastic, where the outer cover 44, the bodyside liner 42 and/or the absorbent chassis 14 include materials that are generally not elastomeric.

As noted previously, the illustrated absorbent article 10 may have front and back side panels 134 and 234 disposed on each side of the absorbent chassis 14 (FIG. 2). These transversely opposed front side panels 134 and transversely opposed back side panels 234 may be permanently bonded to the composite structure 133 of the absorbent chassis 14 and may be releasably attached to one another by a fastening system 40. More particularly, as shown best in FIG. 2, the front side panels 134 may be permanently bonded to and extend transversely beyond the linear side edges 147 of the composite structure 133 along attachment lines 69, and the back side panels 234 may be permanently bonded to and extend transversely beyond the linear side edges of the composite structure 133 along attachment lines 69. The side panels 134 and 234 may be attached using attachment means known to, those skilled in the art such as adhesive, thermal or ultrasonic bonding. The side panels 134 and 234 may also be formed as a portion of a component of the composite structure 133, such as the outer cover 44 or the bodyside liner 42.

Each of the side panels 134 and 234 may include one or more individual, distinct pieces of material. In particular embodiments, for example, each side panel 134 and 234 may include first and second side panel portions that are joined at a seam, with at least one of the portions including an elastomeric material (not shown). Still alternatively, each individual side panel 134 and 234 may include a single piece of material which is folded over upon itself along an intermediate fold line (not shown).

The side panels 134 and 234 may desirably include an elastic material capable of stretching in a direction generally parallel to the transverse axis 49 of the absorbent article 10. In particular embodiments, the front and back side panels 134 and 234 may each include an interior portion 78 disposed between a distal edge 68 and a respective front or back center panel 135 or 235. In the illustrated embodiment in FIG. 2, the interior portions 78 are disposed between the distal edges 68 and the side edges 147 of the rectangular composite structure 133. The elastic material of the side panels 134 and 234 may be disposed in the interior portions 78 to render the side panels 134 and 234 elastomeric in a direction generally parallel to the transverse axis 49. Most desirably, each side panel 134 and 234 may be elastomeric from a waist end edge 72 to a leg end edge 70. More specifically, individual samples of side panel material, taken between the waist end edge 72 and the leg end edge 70 parallel to the transverse axis 49 and having a length from the attachment line 69 to the distal edge 68 and a width of about 2 centimeters, are all elastomeric.

Suitable elastic materials, as well as one described process of incorporating elastic side panels into an absorbent article, such as a training pant, are described in the following U.S. Pat. No. 4,940,464 issued Jul. 10, 1990 to Van Gompel et al.; U.S. Pat. No. 5,224,405 issued Jul. 6, 1993 to Pohjola; 25 U.S. Pat. No. 5,104,116 issued Apr. 14, 1992 to Pohjola; and, U.S. Pat. No. 5,046,272 issued Sep. 10, 1991 to Vogt et al.; all of which are incorporated herein by reference. In particular embodiments, the elastic material includes a sketch-thermal laminate (STL), a neck-bonded laminated (NBL), a reversibly necked laminate, or a stretch-bonded laminate (SBL) material. Methods of making such materials are well known to those skilled in the art and described in U.S. Pat. No. 4,663,220 issued May 5, 1987 to Wisneski et al.; U.S. Pat. No. 5,226,992 issued Jul. 13, 1993 to Morman; and, European Patent Application No. EP 0 217 032 published on Apr. 8, 1987 in the names of Taylor et al.; all of which are incorporated herein by reference. Alternatively, the side panel material may include other woven or nonwoven materials, such as those described above as being suitable for the outer cover 44 or body side liner 42, or stretchable but inelastic materials.

As described herein, the various components of the absorbent article 10 may be integrally assembled together employing various types of suitable attachment means, such as adhesive, sonic and thermal bonds or combinations thereof. The resulting product is an absorbent article 10 including a thin, flexible, high capacity absorbent composite 20. The absorbent article 10 may be sized and tailored for a wide variety of uses including, for example, diapers, training pants, swim wear, incontinence garments, and the like.

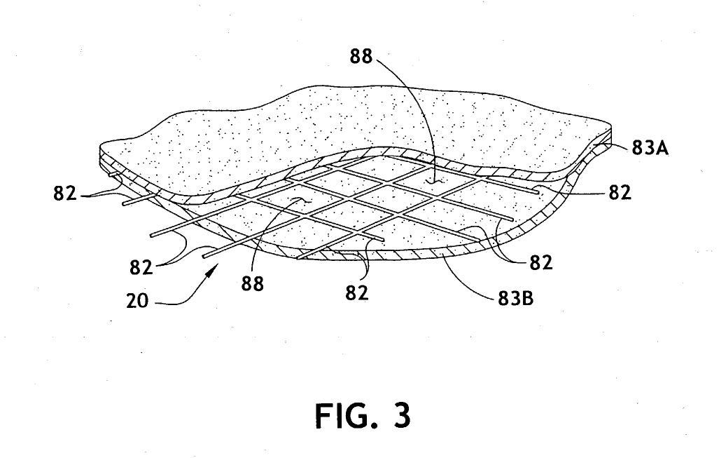

The absorbent composite 20 of the present invention may also incorporate a web of scrim 80 into the absorbent composite 20 of an absorbent article 10. In an embodiment illustrated in FIG. 3, the web of scrim 80 comprises elongate strands 82 which are arranged so that the strands 82 intersect each other. More specifically, the strands 82 may be arranged in a grid including parallel strands extending in the machine-direction 84 and strands extending in the cross-direction 86 defining rectangular openings 88 in the web of scrim 80. Among other things, the openings 88 permit liquid in the absorbent composite 20 to flow substantially unhindered through the web of scrim 80. The strands 82 are secured to each other where the strands 82 intersect to create a lattice providing strength and stability to the absorbent composite 20. In one embodiment of the present invention, the width of the web of scrim 80 may be equal to the width of at least a portion of the absorbent composite 20 (for example, the portion of the absorbent composite 20 which is worn through the crotch region of an absorbent article 10). In other embodiments, the width of the web of scrim 80 may be between about 25% and about 100% of the narrowest width dimension of the absorbent composite 20, and more specifically between about 50% and about 100% of the narrowest width dimension of the absorbent composite 20.

The web of scrim 80 may be made of any suitable material that provides desired levels of strength and flexibility. For example, the strands 82 of the web of scrim 80 may be composed of natural or synthetic materials, as well as combinations thereof. In a particular arrangement, the material of the strands 82 may include a synthetic polymer (e.g., polyester, polyethylene, polypropylene, nylon, rayon). The synthetic polymer may be monofilament, bicomponent or multicomponent. One conventional way to form a web of scrim 80 of such material is to extrude and orient strands to form a net configuration. Another way of forming such material is by a photomasking process. In such a process, a photosensitive resin may be deposited on a woven fabric. A mask is applied in the form of the web of scrim 80 and electromagnetic radiation is used to cure the unmasked portions of the resin. The mask is then removed and the uncured portions of the resin are washed away, leaving the scrim-patterned, cured resin. Natural materials that could be used to form the web of scrim 80 may include cotton, jute, hemp, wool. Alternate materials may include glass, carbon and metallic fibers. The scrim 80 may be a woven or nonwoven material. The strands 82 in the machine-direction 84 and cross direction 86 may also be of different materials. Alternately different materials could be used in alternating strands 82 in the machine-direction 84 and/or cross-direction 86. In one embodiment of the present invention, the strands 82 may be formed of superabsorbent material. As such, the web of scrim 80 may serve a liquid retention function in addition to its reinforcing function. Still further, the web of scrim 80 may be formed of one material and coated with another material, or be a biodegradable material, such as polylactic acid. It will be understood that for different absorbent articles, the webs of scrim 80 having different physical properties would be selected to best meet the needs of the users of the absorbent articles 10.

The position in the z-direction 85 of the web of scrim 80 within the absorbent composite 20 may be selectively changed. The web of scrim 80 may extended the full length of the absorbent composite 20, but may have a lesser or greater length without departing from the scope of the present invention. The absorbent composite 20 has longitudinal edges 100 and 102. The web of scrim 80 may be narrower than the absorbent composite 20 and be arranged so that web of scrim 80 terminates within the longitudinal edges 100 and 102 (shown in FIG. 2) of the absorbent composite 20. In this arrangement, the edges of the web of scrim 80 are embedded in and shielded by the fibers and/or fibrous matrxl of the absorbent composite 20 such that the web of scrim 80 does not irritate the skin or abrade or poke holes in other parts of the absorbent article 10. It is noted that a portion of the absorbent composite 20 is shown in FIG. 3, but extends continuously over its length and embeds the web of scrim 80. It has been found that the web of scrim 80 may help the absorbent composite 20 hold its shape in conformance with the wearer's body thereby improving fit and increasing comfort. In another embodiment of the present invention, However, the web of scrim 80 (not shown) may extend laterally beyond one or both of the longitudinal edges 100 and 102 of the absorbent composite 20.

As shown in FIG. 3, the web of scrim 80 defines a boundary area between the upper and lower regions 83A and 83B, respectively. Where the web of scrim 80 is narrower than the absorbent composite 20, the upper and lower regions 83A and 83B may have no dividing boundary area and are not distinct away from the web of scrim 20. The web of scrim 80 may be incorporated in the absorbent composite 20 in a suitable manner, such as during the formation of the absorbent composite 20. The absorbent composite 20 may be formed by any method known in the art. Such forming methods and apparatus typcially promote the entanglement of the fibers and/or fibrous matrix with the web of scrim 80 and with each other during manufacture of the absorbent composite 20. However, post-formation entanglement such as by needle punching or hydroentangling may be used to further increase this entanglement. It is also believed that entanglement is augmented by passing the absorbent composite 20 containing the web of scrim 80 through a nip or other debulking device.

The interconnection of the upper and lower regions 83A and 83B and the web of scrim 80 is illustrated in FIG. 3. These drawings schematically illustrate the mechanical connections made between the upper region 83A and the lower region 83B, and between both of those regions and web of scrim 80. At least some fibers from the upper region 83A pass through openings 88 in the web of scrim 80 and are entangled with fibers from the lower region 83B. In the same way, at least some of the fibers from the lower region 83B pass through the openings 88 in the web of scrim 80 and are entangled with fibers in the upper region 83A. Thus, the upper and lower regions 83A and 83B are connected to each other by at least fiber entanglement through the web of scrim 80. In addition, at least some fibers from the upper region 83A and at least some fibers from the lower region 83B are entangled with the strands 82 of the web of scrim 80 itself so that mechanical connection is also made with the web of scrim 80. In this way, there is a strong joining of the upper and lower regions 83A and 83B to each other and with the web of scrim 80 so that the web of scrim 80 can reinforce the upper and lower regions 83A and 83B substantially free of any adhesive, fusion or other connection to the absorbent composite 20 other than at least one of: entanglement of the fibers with the web of scrim 80; entanglement of fibers with fibers entangled with the web of scrim 80; and, entanglement of fibers with each other where at least one of the fibers passes through the web of scrim 80. It is recognized that certain processing steps, e.g., debulking, may producing some additional connection between the web of scrim 80 and fibers of the absorbent composite 20, such as by way of hydrogen bonding. For purposes of the present description, such connections do not detract from the connection of the web of scrim 80 with the fibers of the absorbent core 20 being substantially free of connection other than through entanglement. The absorbent composite 20 of the present invention, at least in one embodiment, does not require the use of an adhesive to bond the web of scrim 80 with the fibers of the absorbent composite 20 and does not require fusion of the web of scrim 80 with the fibers to produce a robust and durable absorbent composite 20.

In use, the web of scrim 80 holds the fibers and/or fibrous matrix in the absorbent composite 20 together against loads applied through movement of the wearer and by liquid in the absorbent composite 20 after receiving one or more insults. These loads tend to cause the fibers and/or fibrous matrix (and hence the absorbent composite 20) to tear apart. The web of scrim 80 resists forces applied to the absorbent composite 20 such as but not limited to tensile, compressive, and shear. The web of scrim 80 allows the absorbent composite 20 to have a lower basis weight of fibers and/or fibrous matrix because of the additional strength. Accordingly, the construction of a thinner absorbent composite 20 and a thinner absorbent article 10 is facilitated.

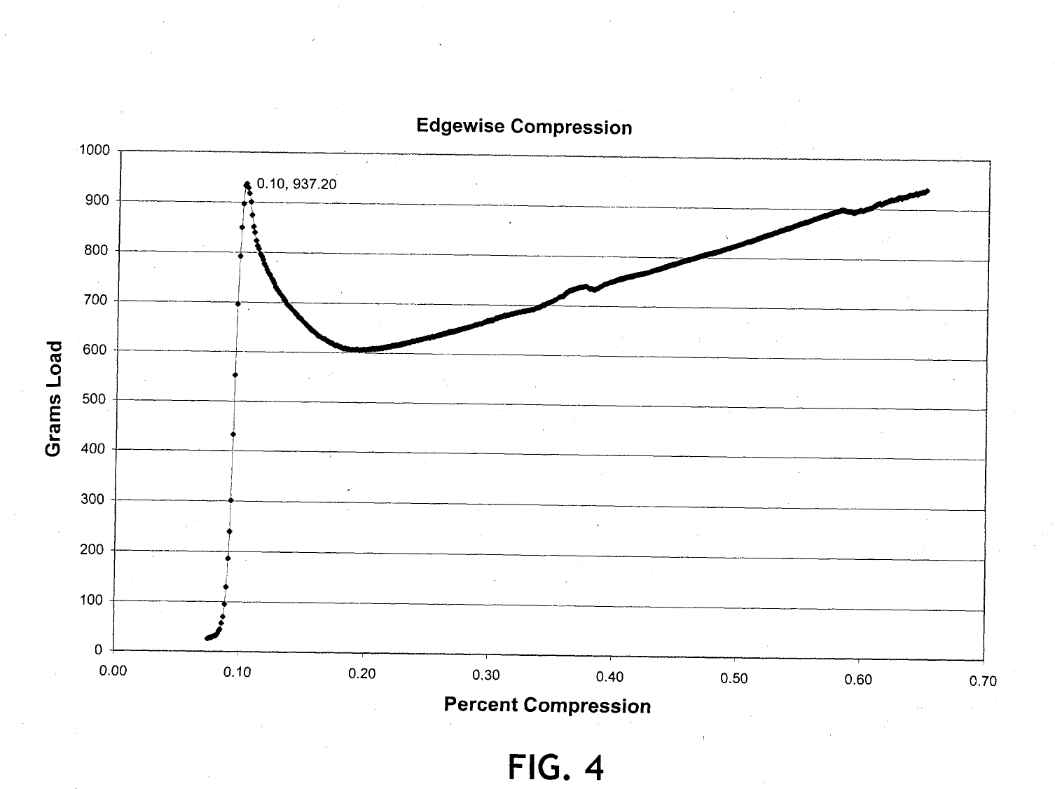

FIG. 3 illustrate one form of the web of scrim 80 composed of strands 82 which intersect each other in a regular fashion and form rectangular openings 88. However, the web of scrim 80 need not have rectangular openings nor be composed of a lattice of strands 82. It is understood that while FIG. 4 shows the web of scrim 80 having retangular-shaped openings 88, the openings 88 may be arranged to define other shapes, including, but not limited to diamond shapes, square shapes, and shapes defined by non-linearly arranged strands and openings within the same scrim having different shapes (not shown).

As stated above, flexibility and conformability of absorbent articles may be desirable properties. Flexibility and conformability of a material are typically evaluated by the ability of the material to bend and twist. Flexibility of a material may also be evaluated by the drapability or lack of stiffness or drapability of the material. A conformable absorbent article would be expected to be characterized by a desired level of flexibility and responsiveness to a user's movements without bunching. The absorbent composite of an absorbent article, in many cases, may greatly impact the flexibility and conformability characteristics of the absorbent article. The components of the absorbent composite may impact these characteristics of the absorbent composite, such as particulate superabsorbent materials or fibrous superabsorbent material, low concentration of superabsorbent materials or high concentration of superabsorbent materials, hardwood fibers or softwood fibers, and synthetic fibers or natural fibers, to name a few component considerations.

Fiber and/or fibrous matrix treated with an additive may require a lower peak/maximum load (in grams) to achieve 50% compression of the fiber or fibrous matrix and/or the absorbent composite into which the fiber or fibrous matrix is incorporated. The term “treated” as used herein is understood to include any means of introducing the additive to the fiber and/or fibrous matrix, but not limited to, such as coating, spraying, printing, chemical modifications, wet-end additions applications to the fibers as well as blending untreated fibers with treated fibers or treated superabsorbent materials with treated or untreated fibers. Treatment may occur prior to or after fiberization process steps are conducted on the fibers and/or fibrous matrix. In accordance with the present invention, the additive may be mineral oil, cotton seed oil, castor oil, oleic acid, silicone oil, and combinations thereof.

Small concentrations of supplemental additives, such as emulsifiers, emollients, waxes, phospholipids, fatty acids, conditioners, hydrocarbons, and/or surfactants in addition to the additive, may help reduce the fiber-bed compression of the fiber and/or fibrous matrix. The supplemental additives may increase the miscibility between a nonpolar additive and a polar additive. The supplemental additives may also play an integral role in coating the swollen fiber and/or fibrous matrix. Various supplemental additives may be used in the present invention depending on the additive used. Examples of emulsifiers are sorbitan phosphatidylcholine and lecithin. Examples of surfactants include sorbitan monolaurate, lecithin, compounds of the TRITON® series (X-100, X-405 & SP-135) available from J. T. Baker, compounds of the BRIJ® series (92 and 97) available from J. T. Baker, polyoxyethylene (80) sorbitan monolaurate, polyoxyethylene sorbitan tetraoleate, and triethanolamine and other alcohol amines, and combinations thereof. When using mixtures of polar and nonpolar compounds, such as friction angle or cohesion value altering additives, emulsifiers, and surfactants, the nonpolar compound may be present in a larger proportion than the polar compound.

The amount of the additives, surfactants, or emulsifiers may be about 1.0% by weight of the dry fiber or less. Optionally, the amount of the additives, surfactants, or emulsifiers may be about 10.0% by weight of the dry fiber or less. Additionally, the amount of the additives, surfactants, or emulsifiers may be about 100.0% by weight of the dry fiber or less. The amount of the additives, surfactants, or emulsifiers may be about 0.001% by weight of the dry fiber or greater. Optionally, the amount of the additives, surfactants, or emulsifiers may be about 0.1% by weight of the dry fiber or greater. Additionally, the amount of the additives, surfactants, or emulsifiers may be about 1.0% by weight of the dry fiber or greater.

In one embodiment of the present invention, the peak/maximum load required to achieve a 50% compression value of the fibers and/or fibrous matrix treated with the additive may be decreased by about 25% or more. Measurement of the decrease in the peak/maximum load is made in accordance with the edgewise compression test as disclosed below. The peak/maximum load required to achieve 50% compression value of the fibers and/or fibrous matrix treated with the additive may be decreased by about 50% or more, more specifically about 65% or more, more specifically about 80% or more, and most specifically about 90% or more. The treated fiber and/or fibrous matrix may be incorporated into an absorbent composite of an absorbent article.

In another embodiment of the present invention, the fibers and/or fibrous matrix treated by the additive and described in the preceding paragraph may be considered in combination wherein the peak/maximum load required to achieve a 50% compression value is about 400 grams or less. Measurement of the peak/maximum load is made in accordance with the edgewise compression test as disclosed below. The peak/maximum load required to achieve a 50% compression value may be about 300 grams or less, more specifically about 200 grams or less, and most specifically about 100 grams or less.

In another embodiment of the present invention, the fibers and/or fibrous matrix described in the two preceding paragraphs may be considered in combination with fibers and/or fibrous matrix comprising hardwood and/or softwood fibers. The absorbent composite into which the fibers and/or fibrous matrix is incorporated may have a basis weight of about 350 grams per square meter or more and/or a density of about 0.2 grams/cc or more. The absorbent composite may also comprise scrim as described above.

In another embodiment of the present invention, the compressive load required to achieve a 50% compression value of the fibers and/or fibrous matrix treated with the additive may be descreased by about 25% or more. Measurement of the decrease in the compressive load is made in accordance with the edgewise compression test as disclosed below. The compressive load required to achieve 50% compression value of the fibers and/or fibrous matrix treated with the additive may be decreased by about 50% or more, more specifically about 65% or more, more specifically about 80% or more, and most specifically about 90% or more. The treated fiber and/or fibrous matrix may be incorporated into an absorbent composite of an absorbent article.

In another embodiment of the present invention, the fibers and/or fibrous matrix treated by the additive and described in the preceding paragraph may be considered in combination wherein the compressive load required to achieve a 50% compression value is about 400 grams or less. Measurement of the decrease in the compression load is made in accordance with the edgewise compression test as disclosed below. The compression load required to achieve a 50% compression value may be about 300 grams or less, more specifically about 200 grams or less, and most specifically about 100 grams or less.

In another embodiment of the present invention, the fibers and/or fibrous matrix described in the two preceding paragraphs may be considered in combination with fibers and/or fibrous matrix comprising hardwood and/or softwood fibers. The absorbent composite into which the fibers and/or fibrous matrix is incorporated may have a basis weight of about 350 grams per square meter or more and/or a density of about 0.2 grams/cc or more. The absorbent composite may also comprise scrim as described above.

In another embodiment of the present invention, the compressive energy (grams-cm) required to achieve a 50% compression value of the fibers and/or fibrous matrix treated with the additive may be descreased by about 25% or more. Measurement of the compressive energy is made in accordance with the edgewise compression test as disclosed below. The compressive energy required to achieve 50% compression value of the fibers and/or fibrous matrix treated with the additive may be decreased by about 50% or more, more specifically about 65% or more, more specifically about 80% or more, and most specifically about 90% or more. The treated fiber and/or fibrous matrix may be incorporated into an absorbent composite of an absorbent article.

In another embodiment of the present invention, the fibers and/or fibrous matrix treated by the additive and described in the preceding paragraph may be considered in combination wherein the compressive energy required to achieve a 50% compression value is about 800 grams-cm or less. Measurement of the compressive energy is made in accordance with the edgewise compression test as disclosed below. The compressive energy required to achieve a 50% compression value may be about 600 grams-cm or less, more specifically about 400 grams-cm or less, and most specifically about 200 grams-cm or less.

In another embodiment of the present invention, the fibers and/or fibrous matrix described in the two preceding paragraphs may be considered in combination with fibers and/or fibrous matrix comprising hardwood and/or softwood fibers. The absorbent composite into which the fibers and/or fibrous matrix is incorporated may have a basis weight of about 350 grams per square meter or more and/or a density of about 0.2 grams/cc or more. The absorbent composite may also comprise scrim as described above.

In one embodiment of the present invention, the peak/maximum load required to achieve a 50% compression value of an absorbent composite comprising superabsorbent material and fibers and/or fibrous matrix may be decreased by about 25% or more. The superabsorbent material, fibers and/or fibrous matrix, and/or both may be treated with the additive. Measurement of the decrease in the peak/maximum load is made in accordance with by the edgewise compression test as disclosed below. The peak/maximum load required to achieve 50% compression value of the absorbent composite comprising superabsorbent material and fibers and/or fibrous matrix may be decreased by about 50% or more, more specifically about 65% or more, more specifically about 75% or more, and most specifically about 85% or more. The absorbent composite may be incorporated into an absorbent article.

In another embodiment of the present invention, the absorbent composite comprising superabsorbent material and the fibers and/or fibrous matrix described in the preceding paragraph may have a peak/maximum load required to achieve a 50% compression value of about 350 grams or less. Measurement of the peak/maximum load is made in accordance with the edgewise compression test as disclosed below. The peak/maximum load required to achieve a 50% compression value may be about 200 grams or less, more specifically about 100 grams or less, and most specifically about 75 grams or less.

In another embodiment of the present invention, the fibers and/or fibrous matrix described in the two preceding paragraphs may be considered in combination with fibers and/or fibrous matrix comprising natural, synthetic, and blends of natural and synthetic fibers. The absorbent composite comprising the superabsorbent material and fibers and/or fibrous matrix, as described above, may have a basis weight of about 350 grams per square meter or more and/or a density of about 0.2 grams/cc or more. The absorbent composite may also comprise scrim as described above.

In another embodiment of the present invention, the compressive load required to achieve a 50% compression value of an absorbent composite comprising superabsorbent material and fibers and/or fibrous matrix may be descreased by about 25% or more. The superabsorbent material, fibers and/or fibrous matrix, and/or both may be treated with the additive. Measurement of the decrease in the compressive load is made in accordance with the edgewise compression test as disclosed below. The compressive load required to achieve 50% compression value of the absorbent composite comprising the superabsorbent material and the fibers and/or fibrous matrix may be decreased by about 50% or more, more specifically about 60% or more, more specifically about 70% or more, and most specifically about 80% or more. The absorbent composite may be incorporated into an absorbent article.

In another embodiment of the present invention, the absorbent composite comprising the superabsorbent material and the fibers and/or fibrous matrix described in the preceding paragraph may have a compressive load required to achieve a 50% compression value of about 200 grams or less. Measurement of the compression load is made in accordance with the edgewise compression test as disclosed below. The compression load required to achieve a 50% compression value may be about 150 grams or less, more specifically about 100 grams or less, and most specifically about 50 grams or less.

In another embodiment of the present invention, the fibers and/or fibrous matrix described in the two preceding paragraphs may be considered in combination with fibers and/or fibrous matrix comprising natural, synthetic, and blends of natural and synthetic fibers. The absorbent composite comprising the superabsorbent material and the fibers and/or fibrous matrix, as described above, may have a basis weight of about 350 grams per square meter or more and/or a density of about 0.2 grams/cc or more. The absorbent composite may also comprise scrim as described above.

In another embodiment of the present invention, the compressive energy (grams-cm) required to achieve a 50% compression value of an absorbent composite comprising the superabsorbent material and fibers and/or fibrous matrix may be descreased by about 25% or more. The superabsorbent material, fibers and/or fibrous matrix, and/or both may be treated with the additive. Measurement of the decrease in the compressive energy is made in accordance with the edgewise compression test as disclosed below. The compressive energy required to achieve 50% compression value of the absorbent composite comprising superabsorbent material and fibers and/or fibrous matrix may be decreased by about 50% or more, more specifically about 65% or more, more specifically about 75% or more, and most specifically about 85% or more. The absorbent composite may be incorporated into an absorbent article.

In another embodiment of the present invention, the absorbent composite comprising the superabsorbent material and the fibers and/or fibrous matrix described in the preceding paragraph may have a compressive energy required to achieve a 50% compression value of about 500 grams-cm or less. Measurement of the compressive energy is made in accordance with the edgewise compression test as disclosed below. The compressive energy required to achieve a 50% compression value may be about 300 grams-cm or less, more specifically about 200 grams-cm or less, and most specifically about 100 grams-cm or less.

In another embodiment of the present invention, the fibers and/or fibrous matrix described in the two preceding paragraphs may be considered in combination with fibers and/or fibrous matrix comprising natural, synthetic, and blends of natural and synthetic fibers. The absorbent composite comprising the superabsorbent material and the fibers and/or fibrous matrix, as described above, is incorporated may have a basis weight of about 350 grams per square meter or more and/or a density of about 0.2 grams/cc or more. The absorbent composite may also comprise scrim as described above.

In accordance with one embodiment of the present invention, a plurality of treated fibers may comprise a plurality of untreated fibers having a peak load value to achieve 50% compression of the plurality of untreated fibers and an additive which interacts with the untreated fibers thereby defining a plurality of treated fibers having a peak load value to achieve 50% compression of the plurality of the treated fibers. The peak load value of the treated fibers may be about 75% of the peak load value of the untreated fibers or less. In the alternative, the peak load value of the treated fibers may be about 10% of the peak load value of the untreated fibers or less. The peak load value of the treated fibers may be about 700 grams or less. In the alternative, the peak load value of the treated fibers may be about 100 grams or less. The untreated fibers may be selected from the group consisting essentially of hardwood fibers, softwood fibers, and combinations thereof.

The additive may be selected from the group consisting essentially of mineral oil, cotton seed oil, castor oil, oleic acid, and combinations thereof. The plurality of treated fibers may further comprise an emulsifier. The emulsifier may be selected from the group consisting essentially of phosphatidylcholine, lecithin, and combinations thereof. The plurality of treated fibers may further comprise a surfactant. The surfactant may be selected from the group consisting essentially of sorbitan monolaurate, compounds of the Triton series, compounds of the Brij series, polyoxyethylene sorbitan monolaurate, polyoxyethylene sorbitan tetraoleate, alcohol amines, and combinations thereof. The treated fibers may be utilized in an absorbent composite. The absorbent composite may further comprise a web of scrim.

In accordance with another embodiment of the present invention, the plurality of treated fibers may comprise a plurality of untreated fibers having a compression value to achieve 50% compression of the plurality of untreated fibers and an additive which interacts with the untreated fibers thereby defining a plurality of treated fibers having a compression value to achieve 50% compression of the plurality of the treated fibers. The compression value of the treated fibers may be about 75% of the compression value of the untreated fibers or less. In the alternative, the compression value of the treated fibers is about 10% of the compression value of the untreated fibers or less. The compression value of the treated fibers may be about 600 grams or less. In the alternative, the compression value of the treated fibers may be about 100 grams or less. The untreated fibers may be selected from the group consisting essentially of hardwood fibers, softwood fibers, and combinations thereof.

The additive may be selected from the group consisting essentially of mineral oil, cotton seed oil, castor oil, oleic acid, and combinations thereof. The plurality of treated fibers may further comprise an emulsifier. The emulsifier may be selected from the group consisting essentially of phosphatidylcholine, lecithin, and combinations thereof. The plurality of treated fibers may further comprise a surfactant. The surfactant may be selected from the group consisting essentially of sorbitan monolaurate, compounds of the Triton series, compounds of the Brij series, polyoxyethylene sorbitan monolaurate, polyoxyethylene sorbitan tetraoleate, alcohol amines, and combinations thereof. The treated fibers may be utilized in an absorbent composite. The absorbent composite may further comprise a web of scrim.

In accordance with another embodiment of the present invention, the plurality of treated fibers may comprise a plurality of untreated fibers having a compressive energy value to achieve 50% compression of the plurality of untreated fibers and an additive which interacts with the untreated fibers thereby defining a plurality of treated fibers having a compressive energy value to achieve 50% compression of the plurality of the treated fibers. The compressive energy value of the treated fibers may be about 75% of the compressive energy value of the untreated fibers or less. In the alternative, the compressive energy value of the treated fibers may be about 10% of the compressive energy value of the untreated fibers or less. The compressive energy value of the treated fibers may be about 1,500 grams-cm or less. In the alternative, the compressive energy value of the treated fibers may be about 200 grams-cm or less. The untreated fibers may be selected from the group consisting essentially of hardwood fibers, softwood fibers, and combinations thereof.

The additive may be selected from the group consisting essentially of mineral oil, cotton seed oil, castor oil, oleic acid, and combinations thereof. The plurality of treated fibers may further comprise an emulsifier. The emulsifier is selected from the group consisting essentially of phosphatidylcholine, lecithin, and combinations thereof. The plurality of treated fibers may further comprise a surfactant. The surfactant may be selected from the group consisting essentially of sorbitan monolaurate, compounds of the Triton series, compounds of the Brij series, polyoxyethylene sorbitan monolaurate, polyoxyethylene sorbitan tetraoleate, alcohol amines, and combinations thereof. The treated fibers may be utilized in an absorbent composite. The absorbent composite may further comprise a web of scrim.

In accordance with another embodiment of the present invention, the absorbent composite may comprise a water swellable, water insoluble superabsorbent material, a plurality of untreated fibers having a peak load value to achieve 50% compression of the plurality of untreated fibers, and an additive which interacts with the untreated fibers thereby defining a plurality of treated fibers having a peak load value to achieve 50% compression of the plurality of the treated fibers. The peak load value of the treated fibers may be about 75% than the peak load value of the untreated fibers or less. In the alternative, the peak load value of the treated fibers may be about 5% or less than the peak load value of the untreated fibers. The peak load value of the treated fibers may be about 350 grams or less. In the alternative, the peak load value of the treated fibers is about 50 grams or less. The plurality of untreated fibers may be selected from the group consisting essentially of natural fibers, synthetic fibers, and combinations thereof.

The additive may be selected from the group consisting essentially of mineral oil, cotton seed oil, castor oil, oleic acid, and combinations thereof. The absorbent composite may further comprise an emulsifier. The emulsifier may be selected from the group consisting essentially of phosphatidylcholine, lecithin, and combinations thereof. The absorbent composite may further comprise a surfactant. The surfactant may be selected from the group consisting essentially of sorbitan monolaurate, compounds of the Triton series, compounds of the Brij series, polyoxyethylene sorbitan monolaurate, polyoxyethylene sorbitan tetraoleate, alcohol amines, and combinations thereof. The absorbent composite may further comprise a web of scrim.

The water swellable, water insoluble superabsorbent material may be selected from the group consisting essentially of natural materials, modified natural materials, synthetic materials, and combinations thereof. The water swellable, water insoluble superabsorbent material may be selected from the group consisting essentially of silica gels, agar, pectin, guar gum, alkali metal salts of polyacrylic acids, polyacrylamides, polyvinyl alcohols, ethylene maleic anhydride copolymers, polyvinyl ethers, hydroxypropylcelluloses, polyvinyl morpholinones, polymers and copolymers of vinyl sulfonic acid, polyacrylates, polyacrylamides, polyvinyl pyridine, acrylonitrile grafted starch, acrylic acid grafted starch, isobutylene maleic anhydride copolymers, polyamines, and combinations thereof. The water swellable, water insoluble superabsorbent material may further comprise a structure selected from the group consisting essentially of particles, fibers, flakes, spheres, and combinations thereof.

In accordance with another embodiment of the present invention, the absorbent composite may comprise a water swellable, water insoluble superabsorbent material, a plurality of untreated fibers having a compression value to achieve 50% compression of the plurality of untreated fibers, and an additive which interacts with the untreated fibers thereby defining a plurality of treated fibers having a compression value to achieve 50% compression of the plurality of the treated fibers. The compression value of the treated fibers may be about 75% of the compression value of the untreated fibers or less. In the alternative, the compression value of the treated fibers may be about 20% of the compression value of the untreated fibers or less. The compression value of the treated fibers may be about 200 grams or less. In the alternative, the compression value of the treated fibers may be about 50 grams or less. The plurality of untreated fibers may be selected from the group consisting essentially of natural fibers, synthetic fibers, and combinations thereof.

The additive may be selected from the group consisting essentially of mineral oil, cotton seed oil, castor oil, oleic acid, and combinations thereof. The absorbent composite may further comprise an emulsifier. The emulsifier may be selected from the group consisting essentially of phosphatidylcholine, lecithin, and combinations thereof. The absorbent composite may further comprising a surfactant. The surfactant may be selected from the group consisting essentially of sorbitan monolaurate, compounds of the Triton series, compounds of the Brij series, polyoxyethylene sorbitan monolaurate, polyoxyethylene sorbitan tetraoleate, alcohol amines, and combinations thereof. The absorbent composite may further comprise a web of scrim.

The water swellable, water insoluble superabsorbent material may be selected from the group consisting essentially of natural materials, modified natural materials, synthetic materials, and combinations thereof. The water swellable, water insoluble superabsorbent material may be selected from the group consisting essentially of silica gels, agar, pectin, guar gum, alkali metal salts of polyacrylic acids, polyacrylamides, polyvinyl alcohols, ethylene maleic anhydride copolymers, polyvinyl ethers, hydroxypropylcelluloses, polyvinyl morpholinones, polymers and copolymers of vinyl sulfonic acid, polyacrylates, polyacrylamides, polyvinyl pyridine, acrylonitrile grafted starch, acrylic acid grafted starch, isobutylene maleic anhydride copolymers, polyamines, and combinations thereof. The water swellable, water insoluble superabsorbent material may further comprise a structure selected from the group consisting essentially of particles, fibers, flakes, spheres, and combinations thereof.

In accordance with another embodiment of the present invention, the absorbent composite may comprise a water swellable, water insoluble superabsorbent material, a plurality of untreated fibers having a compressive energy value to achieve 50% compression of the plurality of untreated fibers, and an additive which interacts with the untreated fibers thereby defining a plurality of treated fibers having a compressive energy value to achieve 50% compression of the plurality of the treated fibers. The compressive energy value of the treated fibers may be about 75% of the compressive energy value of the untreated fibers or less. In the alternative, the the compressive energy value of the treated fibers may be about 20% of the compressive energy value of the untreated fibers or less. The compressive energy value of the treated fibers may be about 500 grams-cm or less. In the alternative, the compressive energy value of the treated fibers may be about 100 grams-cm or less. The plurality of untreated fibers may be selected from the group consisting essentially of natural fibers, synthetic fibers, and combinations thereof.

The additive may be selected from the group consisting essentially of mineral oil, cotton seed oil, castor oil, oleic acid, and combinations thereof. The absorbent composite may further comprising an emulsifier. The emulsifier may be selected from the group consisting essentially of phosphatidylcholine, lecithin, and combinations thereof. The absorbent composite may further comprise a surfactant. The surfactant may be selected from the group consisting essentially of sorbitan monolaurate, compounds of the Triton series, compounds of the Brij series, polyoxyethylene sorbitan monolaurate, polyoxyethylene sorbitan tetraoleate, alcohol amines, and combinations thereof. The absorbent composite may further comprise a web of scrim.

The water swellable, water insoluble superabsorbent material may be selected from the group consisting essentially of natural materials, modified natural materials, synthetic materials, and combinations thereof. The water swellable, water insoluble superabsorbent material may be selected from the group consisting essentially of silica gels, agar, pectin, guar gum, alkali metal salts of polyacrylic acids, polyacrylamides, polyvinyl alcohols, ethylene maleic anhydride copolymers, polyvinyl ethers, hydroxypropylcelluloses, polyvinyl morpholinones, polymers and copolymers of vinyl sulfonic acid, polyacrylates, polyacrylamides, polyvinyl pyridine, acrylonitrile grafted starch, acrylic acid grafted starch, isobutylene maleic anhydride copolymers, polyamines, and combinations thereof. The water swellable, water insoluble superabsorbent material may further comprise a structure selected from the group consisting essentially of particles, fibers, flakes, spheres, and combinations thereof.

### Edgewise Compression Test Procedure

The method by which the Edgewise Compression (EC) test values may be determined is set forth below. A 2-inch by 12-inch (5.1 cm by 30.5 cm) piece of absorbent material is cut with its longer dimension aligned with the longitudinal direction of the product or raw material web. The basis weight of the sample when tested must be 350 grams per squre meter or greater and/or must be 0.2 grams/cc or greater. The weight of the sample is determined. The thickness of the material is determined under a 0.2 psi (1.38 KA) load. The material is formed into a cylinder having a height of 2 inches (5.1 cm), and with the two ends having 0-0.125 inch (0-3.18 mm) overlap, the material is stapled together with three staples. One staple is near the middle of the width of the product, the other two nearer each edge of the width of the material. The longest dimension of the staple is in the circumference of the formed cylinder to minimize the effect of the staples on the testing.

A tensile tester, such as those commercially available from MTS Systems Corporation, Eden Prairie, Minn., is configured with a bottom platform, a platen larger than the diameter of the sample to be tested and parallel to the bottom platform, attached to a compression load cell placed in the inverted position. The specimen is placed on the platform, under the platen. The platen is brought into contact with the specimen and compresses the sample at a rate of 25 mm/min. The maximum force obtained in compressing the sample to 50% of its width (1 inch) (2.54 cm) is recorded.

If the material buckles, it is typical for the maximum force to be reached before the sample is compressed to 50%. In a product where the length of the absorbent is less than 12 inches (30.5 cm), the EC value of the material may be determined in the following mariner. A detailed discussion of the edgewise compression strength has been given in The Handbook Of Physical And Mechanical Testing Of Paper And Paperboard, Richard E. Mark editor, Dekker 1983 (Vol. 1). Based on theoretical models governing buckling stresses, in the Edgewise Compression configuration described, the buckling stress is proportional to E*t²/(H²) with the proportionality constant being a function of H²/(R*t) where E is the Elastic modulus, H is the height of the cylinder, R is the radius of the cylinder, and t is the thickness of the material. Expressing the stress in terms of force per basis weight, it may be shown that the parameter that needs to be maintained constant is H²/R. Therefore, for a sample that is smaller than 12 inches (30.5 cm), the largest possible circle should be constructed and its height (width of the sample being cut out) adjusted such that H²/R equals 2.1 inches (5.3 cm).

Maximum or peak in edgewise compression test is given in grams and is defined as the maximum or peak load measured during path to achieve 50% edgewise compression as described above. Compressive load at 50% compression in edgewise compression test is given in grams and is defined as the compressive load at 50% edgewise compression. Compressive energey to achieve 50% compresision in edgewise compression test is fiven in terms of grams-centimeters and is defined as the area uder the edgewise compression curve, schematically represented in FIG. 4, from 0% to 50% compression. As used herein, the reference to compression means edgewise compression.

The peak compression load typcially occurs at about 5 to about 10% compression. Once the peak compression load has been achieved and the sample has buckled, the load value drops. The compression of the material is then measured as the load is increased at the end of the compression curve. A representative graph is shown in FIG. 4 below.

### EXAMPLES

To demonstrate aspects of the present invention, fiber, designated as NB416, available from Weyerhaeuser, a business having offices in Federal Way, Wash., was treated to reduce the peak/maximum load, to reduce the compressive load at 50% compression, and to reduce the energy required to achieve 50% compression. All airformed fiber-beds and airformed composites (which included 55% superabsorbent material FAVOR® SXM 9543, available from Stockhausen, Inc) were made to a basis weight about 400 grams per square meter with densities about 0.25 grams per cubic centimeter. Those airformed fiber-beds and airformed composites that included treated fiber were made to basis weight about 400 grams per square meter with densities about 0.25 grams per cubic centimeter based upon dry untreated components (fiber and/or sap) only; they were adjusted for the treatment presence. All airformed fiber-bed and airformed composite basis weights reported among the examples reflect this adjustment and are based on dry untreated components.

Treatments used within these examples were either sprayed onto or printed onto both sides of the fiber roll board to achieve desired add on levels. The fibers were then fiberized with a Kamas fiberizer, commercially available from Kamas Industri AB located at Vellinge, Sweden, at settings that gave a 95 or more percentage of fiberization as set forth in the Kamas Cell Mill H.01 manual. The fiberized treated fibers were used to make airformed fiber-beds and airformed composites.

### Control 1

An airformed fiber-bed (with basis weight approximately 380 grams per square meter, and density of about 0.26 grams per cubic centimeter) was made from 100% weight (on dry basis) fluff fibers designated as NB416 (available from Weyerhaeuser, a business having offices in Federal Way, Wash.). The peak (maximum) load (grams) measured during the path to achieve 50% compression, compressive load (grams) at 50% compression, and compressive energy (grams-cm) to achieve 50% compression in edgewise compression test for the airformed fiber bed were measured in accordance with the procedure outlined above. The results are presented in Table 1 below.

TABLE 1
Summary of fiber-bed edgewise compression test - Controls

| | | | Peak load | | |
|---|---|---|---|---|---|
| | BSW | Density | to 50% | Load at 50% | Energy to 50% |
| Fiber | (grams/ | (grams/ | compression | compression | compression |
| Type | cm²) | cm³) | (grams) | (grams) | (grams-cm) |
| NB416 | 381.5 | 0.26 | 499.97 | 426.54 | 944.26 |

### Control 2

An airformed composite (with basis weight approximately 420 grams per square meter, and density of about 0.27 grams per cubic centimeter) was made from 55% weight (on dry basis) of superabsorbent material, untreated/virgin FAVOR® SXM 9543 (available from Stockhausen, inc., a business having offices in Greensboro, N.C.), and 45% weight (on dry basis) fluff fibers designated as NB416 (available from Weyerhaeuser, a business having offices in Federal Way, Wash.). The peak (maximum) load (grams) measured during the path to achieve 50% compression, compressive load (grams) at 50% compression, and compressive energy (grams-cm) to achieve 50% compression in edgewise compression test for the airformed composite were measured in accordance with the procedure outlined above. The results are presented in Table 2 below.

TABLE 2
Summary of SAP/fluff composite edgewise
compression test - Controls

| | | | | | | Energy |
|---|---|---|---|---|---|---|
| | | | | Peak load | Load | to 50% |
| Fiber | | | | to 50% | at 50% | com- |
| Type & | SAP | BSW | Density | com- | com- | pression |
| weight | Type & | (grams/ | (grams/ | pression | pression | (grams- |
| % | weight % | cm²) | cm³) | (grams) | (grams) | cm) |
| NB416 | FAVOR ® | 422.8 | 0.27 | 371.97 | 204.73 | 611.46 |
| 45% | 9543SXM | | | | | |
| | 55% | | | | | |

### Control 3

An airformed fiber-bed (with basis weight aprroximately 390 grams per square meter, and density of about 0.26 grams per cubic centimeter) was made from 100% weight (on dry basis) fluff fibers designated as NB416 (available from Weyerhaeuser, a business having offices in Federal Way, Wash.). A scrim, having dimensions 6 mm×6 mm mesh polypropalene scrim with basis weight—4.8 grams per square meter, (available from Conwed Plastics, a business having offices in Minneapolis, Minn.) is placed somewhat in the middle of the composite to give higher integrity. The peak (maximum) load (grams) measured during the path to achieve 50% compression, compressive load (grams) at 50% compression, and compressive energy (grams-cm) to achieve 50% compression in edgewise compression test for the airformed fiber bed with scrim were measured in accordance with the procedure outlined above. The results are presented in Table 3 below.

TABLE 3
Summary of fiber-bed with scrim edgewise
compression test - Controls

| | | | Peak load | | Energy |
|---|---|---|---|---|---|
| | BSW | Density | to 50% | Load at 50% | to 50% |
| Fiber | (grams/ | (grams/ | compression | compression | compression |
| Type | cm²) | cm³) | (grams) | (grams) | (grams-cm) |
| NB416 | 393.1 | 0.26 | 594.47 | 569.74 | 1136.71 |
| (with | | | | | |
| scrim) | | | | | |

### Control 4

An airformed composite (with basis weight approximately 420 grams per square meter, and density of about 0.27 grams per cubic centimeter) is made from 55% weight (on dry basis) of superabsorbent material, untreated/virgin FAVOR® SXM 9543 (available from Stockhausen, Inc., a business having offices in Greensboro, N.C.), and 45% weight (on dry basis) fluff fibers designated as NB416 (available from Weyerhaeuser, a business having offices in Federal Way, Wash.). A scrim, having dimensions 6 mm×6 mm mesh polypropalene scrim with basis weight—4.8 grams per square meter, (available from Conwed Plastics, a business having offices in Minneapolis, Minn.) is placed somewhat in the middle of the composite to give higher integrity. The peak (maximum) load (grams) measured during the path to achieve 50% compression, compressive load (grams) at 50% compression, and compressive energy (grams-cm) to achieve 50% compression in edgewise compression test for the airformed composite with scrim were measured in accordance with the procedure outlined above. The results are presented in Table 4 below.

TABLE 4
Summary of SAP/fluff composite with scrim edgewise
compression test - Controls

| | | | | | | Energy |
|---|---|---|---|---|---|---|
| | | | | Peak load | Load | to 50% |
| Fiber | | | | to 50% | at 50% | com- |
| Type & | SAP | BSW | Density | com- | com- | pression |
| weight | Type & | (grams/ | (grams/ | pression | pression | (grams- |
| % | weight % | cm²) | cm³) | (grams) | (grams) | cm) |
| NB416 | FAVOR ® | 421.1 | 0.27 | 424.40 | 231.60 | 675.13 |
| 45% | 9543SXM | | | | | |
| (with | 55% | | | | | |
| scrim) | | | | | | |

### Example 1

Fluff fibers designated as NB416 (available from Weyerhaeuser, a business having offices in Federal Way, Wash.) were coated with Mineral Oil. (CAS 8012-95-1, available from Mallinckrodt Baker, having business offices in Phillipsburg, N.J.) and Lecithin (CAS 8002-43-5, available from Spectrum Quality Products, Inc., a business having offices in Gardena, Calif.), following procesure outlined above, in a ratio given in TABLE 5. The coating/additive was a mixture of Mineral Oil and Lecithin in a ratio as given in TABLE 5. An airformed fiber-bed (with basis weight approximately 385 grams per square meter, and density of about 0.24 grams per cubic centimeter) was made of the coated fluff fibers. The peak (maximum) load (grams) measured during path to achieve 50% compression, compressive load (grams) at 50% compression, and compressive energy (grams-cm) to achieve 50% compression in edgewise compression test for the airformed fiber bed were measured in accordance with the procedure outlined above. The results are presented in Table 5 below.

TABLE 5
Summary of treated/coated fiber-bed edgewise compression test

| | | | | | Peak | | Energy |
|---|---|---|---|---|---|---|---|
| | | | | | load | Load | to 50% |
| | | | | | to 50% | at 50% | com- |
| | | Lec- | BSW | Density | com- | com- | pression |
| Fiber | MO | ithin | (grams/ | (grams/ | pression | pression | (grams- |
| Wt % | wt % | wt % | cm²) | cm³) | (grams) | (grams) | cm) |
| 80% | 19% | 1% | 383.8 | 0.23 | 63.65 | 51.84 | 112.88 |
| 95% | 4.75% | .25% | 388.6 | 0.24 | 79.80 | 79.80 | 160.86 |
| 97.5% | 2.25% | .25% | 389.7 | 0.24 | 77.78 | 64.17 | 142.39 |

### Example 2

Fluff fibers designated as NB416 (available from Weyerhaeuser, a business having offices in Federal Way, Wash.) were coated with Mineral Oil (CAS 8012-95-1, available from Mallinckrodt Baker, having business offices in Phillipsburg, N.J.) and Lecithin (CAS 8002-43-5, available from Spectrum Quality Products, Inc., a business having offices in Gardena, Calif.), following procesure outlined above, in a ratio given in TABLE 6. The coating/additive was a mixture of Mineral Oil and Lecithin in a ratio as given in TABLE 6. An airformed fiber-bed (with basis weight approximately 390 grams per square meter, and density of about 0.23 grams per cubic centimeter) was made of the coated fluff fibers. A scrim, having dimensions 6 mm×6 mm mesh polypropylene scrim with basis weight—4.8 grams per square meter, (available from Conwed Plastics, a business having offices in Minneapolis, Minn.) is placed approximately in the middle of the composite to give higher integrity. The peak (maximum) load (grams) measured during path to achieve 50% compression, compressive load (grams) at 50% compression, and compressive energy (grams-cm) to achieve 50% compression in edgewise compression test for the airformed fiber bed were measured in accordance with the procedure outlined above. The results are presented in Table 6 below.

TABLE 6
Summary of treated/coated fiber-bed
with scrim edgewise compression test

| | | | | | Peak | | Energy |
|---|---|---|---|---|---|---|---|
| | | | | | load | Load | to 50% |
| | | | | | to 50% | at 50% | com- |
| | | Lec- | BSW | Density | com- | com- | pression |
| Fiber | MO | ithin | (grams/ | (grams/ | pression | pression | (grams- |
| Wt % | wt % | wt % | cm²) | cm³) | (grams) | (grams) | cm) |
| 80% | 9% | 1% | 388.2 | 0.23 | 78.62 | 68.55 | 153.56 |
| 95% | 4.75% | .25% | 392.2 | 0.23 | 112.12 | 76.60 | 194.03 |
| 97.5% | 2.25% | .25% | 391.6 | 0.23 | 75.16 | 64.37 | 147.96 |

### Example 3

Fluff fibers designated as NB416 (available from Weyerhaeuser, a business having offices in Federal Way, Wash.) were coated with Mineral Oil (CAS 8012-95-1, available from Mallinckrodt Baker, having business offices in Phillipsburg, N.J.) and Lecithin (CAS 8002-43-5, available from Spectrum Quality Products, Inc., a business having offices in Gardena, Calif.), following procesure outlined above, in a ratio given in TABLE 7. The coating/additive was a mixture of Mineral Oil and Lecithin in a ratio as given in TABLE 7. An airformed composite (with basis weight approximately 430 grams per square meter, and density of about 0.26 grams per cubic centimeter) is made from 55% weight (on dry basis) of superabsorbent material, untreated/virgin FAVOR® SXM 9543 (available from Stockhausen, inc., a business having offices in Greensboro, N.C.), and 45% weight (on dry basis) fluff fibers designated as NB416 (available from Weyerhaeuser, a business having offices in Federal Way, Wash.). The peak (maximum) load (grams) measured during path to achieve 50% compression, compressive load (grams) at 50% compression, and compressive energy (grams-cm) to achieve 50% compression in edgewise compression test for the airformed composite were measured in accordance with the procedure outlined above. The results are presented in Table 7 below.

TABLE 7
Summary of composite with treated/coated
fibers edgewise compression test

| | | | | | Peak | | Energy |
|---|---|---|---|---|---|---|---|
| | | | | | load | Load | to 50% |
| | | | | | to 50% | at 50% | com- |
| | | Lec- | BSW | Density | com- | com- | pression |
| Fiber | MO | ithin | (grams/ | (grams/ | pression | pression | (grams- |
| Wt % | wt % | wt % | cm²) | cm³) | (grams) | (grams) | cm) |
| 80% | 19% | 1% | 423.0 | 0.27 | 24.39 | 23.95 | 50.02 |
| 95% | 4.75% | .25% | 426.7 | 0.26 | 34.91 | 33.54 | 62.88 |
| 97.5% | 2.25% | .25% | 434.2 | 0.26 | 45.09 | 44.98 | 79.60 |

### Example 4

Fluff fibers designated as NB416 (available from Weyerhaeuser, a business having offices in Federal Way, Wash.) were coated with Mineral Oil (CAS 8012-95-1, available from Mallinckrodt Baker, having business offices in Phillipsburg, N.J.) and Lecithin (CAS 8002-43-5, available from Spectrum Quality Products, Inc., a business having offices in Gardena, Calif.), following procesure outlined above, in a ratio given in TABLE 8. The coating/additive was a mixture of Mineral Oil and Lecithin in a ratio as given in TABLE 8. An airformed composite (with basis weight approximately 430 grams per square meter, and density of about 0.25 grams per cubic centimeter) is made from 55% weight (on dry basis) of superabsorbent material, untreated/virgin FAVOR® SXM 9543 (available from Stockhausen, inc., a business having offices in Greensboro, N.C.), and 45% weight (on dry basis) fluff fibers designated as NB416 (available from Weyerhaeuser, a business having offices in Federal Way, Wash.). A scrim, having dimensions 6 mm×6 mm mesh polypropylene scrim with basis weight—4.8 grams per square meter, (available from Conwed Plastics, a business having offices in Minneapolis, Minn.) is placed approximately in the middle of the composite to give higher integrity. The peak (maximum) load (grams) measured during path to achieve 50% compression, compressive load (grams) at 50% compression, and compressive energy (grams-cm) to achieve 50% compression in edgewise compression test for the airformed composite were measured in accordance with the procedure outlined above. The results are presented in Table 8 below.

TABLE 8
Summary of composite with treated/coated fibers and
with scrim edgewise compression test

| | | | | | Peak | | Energy |
|---|---|---|---|---|---|---|---|
| | | | | | load | Load | to 50% |
| | | | | | to 50% | at 50% | com- |
| | | Lec- | BSW | Density | com- | com- | pression |
| Fiber | MO | ithin | (grams/ | (grams/ | pression | pression | (grams- |
| Wt % | wt % | wt % | cm²) | cm³) | (grams) | (grams) | cm) |
| 80% | 19% | 1% | 423.7 | 0.26 | 42.61 | 41.98 | 89.87 |
| 95% | 4.75% | .25% | 427.8 | 0.25 | 50.27 | 47.19 | 106.01 |
| 97.5% | 2.25% | .25% | 430.3 | 0.25 | 50.46 | 45.65 | 102.19 |

We claim:

1. A plurality of treated fibers, comprising:
a plurality of untreated fibers having a peak load value to achieve 50% compression of the plurality of untreated fibers; and,
an additive which interacts with the untreated fibers thereby defining a plurality of treated fibers having a peak load value to achieve 50% compression of the plurality of the treated fibers,
wherein the peak load value of the treated fibers is about 75% of the peak load value to achieve 50% compression of the untreated fibers or less.

2. The plurality of treated fibers of claim 1, wherein the peak load value of the treated fibers is about 10% of the peak load value of the untreated fibers or less.

3. The plurality of treated fibers of claim 1, wherein the peak load value of the treated fibers is about 400 grams or less.

4. The plurality of treated fibers of claim 1, wherein the peak load value of the treated fibers is about 100 grams or less.

5. The plurality of treated fibers of claim 1, wherein the untreated fibers are selected from the group consisting essentially of hardwood fibers, softwood fibers, and combinations thereof.

6. The plurality of treated fibers of claim 1, wherein the additive is selected from the group consisting essentially of mineral oil, cotton seed oil, castor oil, oleic acid, silicone oil, and combinations thereof.

7. The plurality of treated fibers of claim 1, further comprising an emulsifier.

8. The plurality of treated fibers of claim 7, wherein the emulsifier is selected from the group consisting essentially of phosphatidylcholine, lecithin; and combinations thereof.

9. The plurality of treated fibers of claim 1, further comprising a surfactant.

10. The plurality of treated fibers of claim 9, wherein the surfactant is selected from the group consisting essentially of sorbitan monolaurate, compounds of the Triton series, compounds of the Brij series, polyoxyethylene sorbitan monolaurate, polyoxyethylene sorbitan tetraoleate, alcohol amines, and combinations thereof.

11. An absorbent composite comprising a plurality of treated fibers as set forth in claim 1.

12. An absorbent composite comprising a web of scrim and a plurality of treated fibers as set forth in claim 1.

13. A plurality of treated fibers, comprising:
a plurality of untreated fibers having a compressive load at 50% compression of the plurality of untreated fibers; and,
an additive which interacts with the untreated fibers thereby defining a plurality of treated fibers having a compressive load at 50% compression of the plurality of the treated fibers,
wherein the compressive load of the treated fibers is about 75% of the compressive load of the untreated fibers or less.

14. The plurality of treated fibers of claim 13, wherein the compressive load of the treated fibers is about 10% of the compressive load of the untreated fibers or less.

15. The plurality of treated fibers of claim 13, wherein the compressive load of the treated fibers is about 400 grams or less.

16. The plurality of treated fibers of claim 13, wherein the compressive load of the treated fibers is about 100 grams or less.

17. The plurality of treated fibers of claim 13, wherein the untreated fibers are selected from the group consisting essentially of hardwood fibers, softwood fibers, and combinations thereof.

18. The plurality of treated fibers of claim 13, wherein the additive is selected from the group consisting essentially of mineral oil, cotton seed oil, castor oil, oleic acid, silicone oil, and combinations thereof.

19. The plurality of treated fibers of claim 13, further comprising an emulsifier.

20. The plurality of treated fibers of claim 19, wherein the emulsifier is selected from the group consisting essentially of phosphatidylcholine, lecithin, and combinations thereof.

21. The plurality of treated fibers of claim 13, further comprising a surfactant.

22. The plurality of treated fibers of claim 21, wherein the surfactant is selected from the group consisting essentially of sorbitan monolaurate, compounds of the Triton series, compounds of the Brij series, polyoxyethylene sorbitan monolaurate, polyoxyethylene sorbitan tetraoleate, alcohol amines, and combinations thereof.

23. An absorbent composite comprising a plurality of treated fibers as set forth in claim 13.

24. An absorbent composite comprising a web of scrim and a plurality of treated fibers as set forth in claim 13.

25. A plurality of treated fibers, comprising:
a plurality of untreated fibers having a compressive energy value to achieve 50% compression of the plurality of untreated fibers; and,
an additive which interacts with the untreated fibers thereby defining a plurality of treated fibers having a compressive energy value to achieve 50% compression of the plurality of the treated fibers,
wherein the compressive energy value of the treated fibers is about 75% of the compressive energy value of the untreated fibers or less.

26. The plurality of treated fibers of claim 25, wherein the compressive energy value of the treated fibers is about 10% of the compressive energy value of the untreated fibers or less.

27. The plurality of treated fibers of claim 25, wherein the compressive energy value of the treated fibers is about 800 grams-cm or less.

28. The plurality of treated fibers of claim 25, wherein the compressive energy value of the treated fibers is about 200 grams-cm or less.

29. The plurality of treated fibers of claim 25, wherein the untreated fibers are selected from the group consisting essentially of hardwood fibers, softwood fibers, and combinations thereof.

30. The plurality of treated fibers of claim 25, wherein the additive is selected from the group consisting essentially of mineral oil, cotton seed oil, castor oil, oleic acid, silicone oil, and combinations thereof.

31. The plurality of treated fibers of claim 25, further comprising an emulsifier.

32. The plurality of treated fibers of claim 31, wherein the emulsifier is selected from the group consisting essentially of phosphatidylcholine, lecithin, and combinations thereof.

33. The plurality of treated fibers of claim 25, further comprising a surfactant.

34. The plurality of treated fibers of claim 33, wherein the surfactant is selected from the group consisting essentially of sorbitan monolaurate, compounds of the Triton series, compounds of the Brij series, polyoxyethylene sorbitan monolaurate, polyoxyethylene sorbitan tetraoleate, alcohol amines, and combinations thereof.

35. An absorbent composite comprising a plurality of treated fibers as set forth in claim 25.

36. An absorbent composite comprising a web of scrim and a plurality of treated fibers as set forth in claim 25.

37. An absorbent composite, comprising:
a water swellable, water insoluble superabsorbent material;
a plurality of untreated fibers having a peak load value to achieve 50% compression of the plurality of untreated fibers; and,
an additive which interacts with the untreated fibers thereby defining a plurality of treated fibers having a peak load value to achieve 50% compression of the plurality of the treated fibers,
wherein the peak load value of the treated fibers is about 75% of the peak load value of the untreated fibers or less.

38. The absorbent composite of claim 37, wherein the peak load value of the treated fibers is about 15% of the peak load value of the untreated fibers or less.

39. The absorbent composite of claim 37, wherein the peak load value of the treated fibers is about 350 grams or less.

40. The absorbent composite of claim 37, wherein the peak load value of the treated fibers is about 75 grams or less.

41. The absorbent composite of claim 37, wherein the additive is selected from the group consisting essentially of mineral oil, cotton seed oil, castor oil, oleic acid, silicone oil, and combinations thereof.

42. The absorbent composite of claim 37, further comprising an emulsifier.

43. The absorbent composite of claim 42, wherein the emulsifier is selected from the group consisting essentially of phosphatidylcholine, lecithin, and combinations thereof.

44. The absorbent composite of claim 37, further comprising a surfactant.

45. The absorbent composite of claim 44, wherein the surfactant is selected from the group consisting essentially of sorbitan monolaurate, compounds of the Triton series, compounds of the Brij series, polyoxyethylene sorbitan monolaurate, polyoxyethylene sorbitan tetraoleate, alcohol amines, and combinations thereof.

46. The absorbent composite of claim 37, further comprising a web of scrim.

47. The absorbent composite of claim 37, wherein the water swellable, water insoluble superabsorbent material is selected from the group consisting essentially of natural materials, modified natural materials, synthetic materials, and combinations thereof.

48. The absorbent composite of claim 47, wherein the water swellable, water insoluble superabsorbent material is selected from the group consisting essentially of silica gels, agar, pectin, guar gum, alkali metal salts of polyacrylic acids, polyacrylamides, polyvinyl alcohols, ethylene maleic anhydride copolymers, polyvinyl ethers, hydroxypropylcelluloses, polyvinyl morpholinones, polymers and copolymers of vinyl sulfonic acid, polyacrylates, polyacrylamides, polyvinyl pyridine, acrylonitrile grafted starch, acrylic acid grafted starch, isobutylene maleic anhydride copolymers, polyamines, and combinations thereof.

49. The absorbent composite of claim 37, wherein the water swellable, water insoluble superabsorbent material further comprising a structure selected from the group consisting essentially of particles, fibers, flakes, spheres, and combinations thereof.

50. The absorbent composite of claim 37, wherein the plurality of untreated fibers is selected from the group consisting essentially of natural fibers, synthetic fibers, and combinations thereof.

51. An absorbent composite, comprising:
a water swellable, water insoluble superabsorbent material;
a plurality of untreated fibers having a compressive load at 50% compression of the plurality of untreated fibers; and,
an additive which interacts with the untreated fibers thereby defining a plurality of treated fibers having a compressive load at 50% compression of the plurality of the treated fibers,
wherein the compressive load of the treated fibers is about 75% of the compressive load of the untreated fibers or less.

52. The absorbent composite of claim 51, wherein the compressive load of the treated fibers is about 20% of the compressive load of the untreated fibers or less.

53. The absorbent composite of claim 51, wherein the compressive load of the treated fibers is about 200 grams or less.

54. The absorbent composite of claim 51, wherein the compressive load of the treated fibers is about 50 grams or less.

55. The absorbent composite of claim 51, wherein the additive is selected from the group consisting essentially of mineral oil, cotton seed oil, castor oil, oleic acid, silicone oil, and combinations thereof.

56. The absorbent composite of claim 51, further comprising an emulsifier.

57. The absorbent composite of claim 56, wherein the emulsifier is selected from the group consisting essentially of phosphatidylcholine, lecithin, and combinations thereof.

58. The absorbent composite of claim 51, further comprising a surfactant.

59. The absorbent composite of claim 58, wherein the surfactant is selected from the group consisting essentially of sorbitan monolaurate, compounds of the Triton series, compounds of the Brij series, polyoxyethylene sorbitan monolaurate, polyoxyethylene sorbitan tetraoleate, alcohol amines, and combinations thereof.

60. The absorbent composite of claim 51, further comprising a web of scrim.

61. The absorbent composite of claim 51, wherein the water swellable, water insoluble superabsorbent material is selected from the group consisting essentially of natural materials, modified natural materials, synthetic materials, and combinations thereof.

62. The absorbent composite of claim 61, wherein the water swellable, water insoluble superabsorbent material is selected from the group consisting essentially of silica gels, agar, pectin, guar gum, alkali metal salts of polyacrylic acids, polyacrylamides, polyvinyl alcohols, ethylene maleic anhydride copolymers, polyvinyl ethers, hydroxypropylcelluloses, polyvinyl morpholinones, polymers and copolymers of vinyl sulfonic acid, polyacrylates, polyacrylamides, polyvinyl pyridine, acrylonitrile grafted starch, acrylic acid grafted starch, isobutylene maleic anhydride copolymers, polyamines, and combinations thereof.

63. The absorbent composite of claim 51, wherein the water swellable, water insoluble superabsorbent material further comprises a structure selected from the group consisting essentially of particles, fibers, flakes, spheres, and combinations thereof.

64. The absorbent composite of claim 51, wherein the plurality of untreated fibers is selected from the group consisting essentially of natural fibers, synthetic fibers, and combinations thereof.

65. An absorbent composite, comprising:
a water swellable, water insoluble superabsorbent material;
a plurality of untreated fibers having a compressive energy value to achieve 50% compression of the plurality of untreated fibers; and,
an additive which interacts with the untreated fibers thereby defining a plurality of treated fibers having a compressive energy value to achieve 50% compression of the plurality of the treated fibers,
wherein the compressive energy value of the treated fibers is about 75% of the compressive energy value of the untreated fibers or less.

66. The absorbent composite of claim 65, wherein the compressive energy value of the treated fibers is about 15% of the compressive energy value of the untreated fibers or less.

67. The absorbent composite of claim 65, wherein the compressive energy value of the treated fibers is about 500 grams-cm or less.

68. The absorbent composite of claim 65, wherein the compressive energy value of the treated fibers is about 100 grams-cm or less.

69. The absorbent composite of claim 65, wherein the additive is selected from the group consisting essentially of mineral oil, cotton seed oil, castor oil, oleic acid, silicone oil, and combinations thereof.

70. The absorbent composite of claim 65, further comprising an emulsifier.

71. The absorbent composite of claim 70, wherein the emulsifier is selected from the group consisting essentially of phosphatidylcholine, lecithin, and combinations thereof.

72. The absorbent composite of claim 65, further comprising a surfactant.

73. The absorbent composite of claim 72, wherein the surfactant is selected from the group consisting essentially of sorbitan monolaurate, compounds of the Triton series, compounds of the Brij series, polyoxyethylene sorbitan monolaurate, polyoxyethylene sorbitan tetraoleate, alcohol amines, and combinations thereof.

74. The absorbent composite of claim 65, further comprising a web of scrim.

75. The absorbent composite of claim 65, wherein the water swellable, water insoluble superabsorbent material is selected from the group consisting essentially of natural materials, modified natural materials, synthetic materials, and combinations thereof.

76. The absorbent composite of claim 75, wherein the water swellable, water insoluble superabsorbent material is selected from the group consisting essentially of silica gels, agar, pectin, guar gum, alkali metal salts of polyacrylic acids, polyacrylamides, polyvinyl alcohols, ethylene maleic anhydride copolymers, polyvinyl ethers, hydroxypropylcelluloses, polyvinyl morpholinones, polymers and copolymers of vinyl sulfonic acid, polyacrylates, polyacrylamides, polyvinyl pyridine, acrylonitrile grafted starch, acrylic acid grafted starch, isobutylene maleic anhydride copolymers, polyamines, and combinations thereof.

77. The absorbent composite of claim 65, wherein the water swellable, water insoluble superabsorbent material further comprises a structure selected from the group consisting essentially of particles, fibers, flakes, spheres, and combinations thereof.

78. The absorbent composite of claim 65, wherein the plurality of untreated fibers is selected from the group consisting essentially of natural fibers, synthetic fibers, and combinations thereof.
